(19) United States
(12) Patent Application Publication
(10) Pub. No.: US 2005/0201096 A1
(43) Pub. Date: Sep. 15, 2005

(54) Object detecting apparatus for vehicle

(76) Inventor: Takekazu Terui, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/075,181

(22) Filed: Mar. 8, 2005

(30) Foreign Application Priority Data
Mar. 9, 2004 (JP) 2004-065925

(51) Int. Cl. F21V 1/00

(52) U.S. Cl. 362/276

(57) ABSTRACT

In an object detecting apparatus, a light emission portion emits a light toward a front of the vehicle. A light detection portion detects the light reflected by an object. A housing locates therein the light emission portion and the light detection portion in a generally vertical direction and installed behind a covering portion at a front of the vehicle. The covering portion passes the light therethrough and gradually retracts in a fore-and-aft direction of the vehicle from a front of the light emission portion to a front of the light detection portion.

### CROSS REFERENCE TO RELATED APPLICATION

This application is based upon and claims the benefit of priority of Japanese Patent Applications No. 2004-065925 filed on Mar. 9, 2004, the content of which is incorporated herein by reference.

### FIELD OF THE INVENTION

The present invention relates to an object detecting apparatus for a vehicle, which is especially suitable for detecting a distance to an object such as a forward vehicle.

### BACKGROUND OF THE INVENTION

A conventional object detecting apparatus emits intermittently a laser light and detects the laser light reflected by an object such as a forward vehicle to detect a distance to the object based on a time lag between an emission and a detection of the laser light.

JP2002-31685A discloses an object detecting apparatus located on a vehicle and comprising a light emitter for emitting laser light, a pivotally movable polygon mirror for reflecting the laser light to the scanning range in front of the vehicle and a photoreceptor for detecting the laser light reflected by the object. The above object detecting apparatus is located in a hollow formed in a front bumper of the vehicle. This configuration impairs the worth of the appearance of the vehicle.

It is therefore proposed to locate the object detecting apparatus behind a grille cover of the vehicle, and to emit and to receive the laser light through clearances or transparent portions of the grille cover.

FIGS. 5A and 5B depict the arrangement of the proposed object detecting apparatus above. When the object detecting apparatus is located behind the grille cover J1, the laser light may be reflected on a rear face of the grille cover J1 and enter the photoreceptor, influencing a detection accuracy of reflected light by the photoreceptor.

Assuming a case that horizontal angles of the emission and the reception of the laser light are respectively ±18 degrees, as shown in FIG. 5A, a short distance between a light emission aperture J2 and a light reception aperture J3 makes the emitted light transmitted through the aperture J2 and reflected on the rear face of the grille cover J1 enter the light reception aperture J3 as a stray light.

To prevent the stray light from entering the light reception aperture, as shown in FIG. 5B, it is required to extend the distance between the light emission aperture J2 and the light reception aperture J3. However, a large distance between the light emission aperture J2 and the light reception aperture J3 makes the object detecting apparatus large, heavy and expensive.

### SUMMARY OF THE INVENTION

The object of the present invention is to provide an object detecting apparatus for a vehicle, which is located behind a grill cover, capable of decreasing an influence by a stray light and a diffusive light on accuracy of detection of a laser light.

To achieve the above object, an object detecting apparatus for a vehicle having a covering portion passing light therethrough and tilted relative to a vertical direction comprises a light emission portion for emitting a light toward outside of a vehicle, a light detection portion for detecting the light reflected by an object and a housing configured to be installed behind the covering portion and locating therein the light emission portion and the light detection portion generally in a vertical direction so that the light emission portion faces more outward portion of the covering portion than a portion which the light reception portion faces.

### BRIEF DESCRIPTION OF THE DRAWINGS

Other objects, features and advantages of the present invention will be appreciated, as well as methods of operation and the function of the related parts, from a study of the following detailed description, the appended claims, and the drawings, all of which form a part of this application. In the drawings:

FIG. 1 is a sectional view of an object detecting apparatus according to a first embodiment of the present invention;

FIG. 2 is a sectional view of an object detecting apparatus according to a second embodiment of the present invention;

FIG. 3 is a sectional view of an object detecting apparatus according to a third embodiment of the present invention;

FIG. 4 is a sectional view of an object detecting apparatus according to a fourth embodiment of the present invention;

FIG. 5A is a schematic view of an object detecting apparatus according to a related art; and

FIG. 5B is a schematic view of another object detecting apparatus according to a related art.

### DESCRIPTION OF THE PREFERRED EMBODIMENTS

### First Embodiment

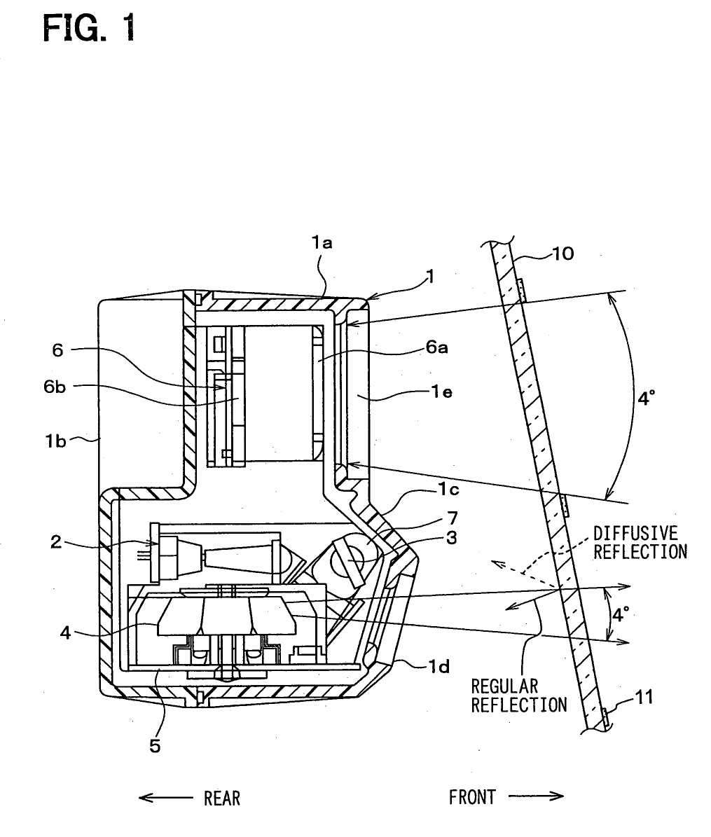

FIG. 1 depicts an object detecting apparatus located behind a transparent grille cover 10 at a front of a vehicle. The object detecting apparatus serves, for example, as a laser radar for detecting an object and further measuring a distance between the vehicle and another forward vehicle for an adaptive cruise control system.

A housing 1 of the object detecting apparatus is a generally parallelepiped plastic box. A first portion 1a and a second portion 1b compose the housing 1. The first portion 1a is a box having an opening on a rear face at a rear side of the vehicle and encloses respective components described below.

The first portion 1a has a black-colored light-shielding plastic portion 1c forming most portion thereof. The first portion 1a further has a light emission aperture 1d and a light reception aperture 1e on a front face thereof at the front side. The apertures 1d and 1e are arranged generally in a vertical direction and made of a transparent material such as a glass or an acrylic.

The light emission aperture 1d and the light reception aperture 1e are separated in a vertical direction leaving a distance therebetween. For example, in a case that the grille cover 10 has horizontal stripe coatings 11 on a face thereof, the distance is set so that each of the light emission aperture 1d and the light reception aperture 1e faces a non-coated spacing between the stripe coatings 11.

The front face of the first portion 1a has a stepped section so as to locate the light emission aperture 1d ahead of light reception aperture 1e thereon. The second portion 1b is made of plastic, etc., and attached to the opening of the first portion 1a. The second portion 1b holds a connector thereon. Although not shown, this connector is for electrical communication between the object detecting apparatus and a main ECU (electrical control unit) of the vehicle.

The housing 1 encloses a light emitter 2, a reflector 3, a polygon mirror 4 and a circuit board 5 in a lower portion thereof. The circuit board 5 includes a control portion (not shown) to control the object detecting apparatus. The housing 1 further encloses a photoreceptor 6 in an upper portion thereof to face the light reception aperture 1e.

The light emitter 2 operates to emit laser lights to the reflector 3, based on a signal sent by the control portion of the circuit board 5. A laser diode generating pulse laser light serves as the light emitter 2, for example.

The reflector 3 reflects the laser light emitted by the light emitter 2 toward the polygon mirror 4. A holder 7 pivotally holds the reflector 3, and an actuator driven by the signal of the control portion adjusts a vertical reflection angle of the reflector 3, for example within a range of ±1 degree.

The polygon mirror 4 has a generally hexagonal pyramid shape, whose tip is cut off, and reflects further the laser light forward in front of the vehicle through the light emission aperture 1d. An actuator rotates the polygon mirror 4 around a vertical axis so as to change a reflection angle of the laser light, so as to adjust the emission angle of the laser light to scan over a predetermined range in front of the vehicle.

The configuration above emits the laser light forward generally within a range of 4 degrees in a vertical direction and ±18 degrees in a horizontal direction. The light emission aperture 1d faces the spacing between the stripe coatings 11 of the grille cover 10 so as to emit the laser light through the light emission aperture 1d.

The circuit board 5 comprises a control portion having an object detection and distance detection portion calculating the distance between the vehicle and the forward vehicle. The control portion sends signals to operate respective devices such as the light emitter 2, reflector 3 and polygon mirror 4, and receives signals from the photoreceptor 6, then calculates the distance.

The photoreceptor 6 is located generally above the polygon mirror 4 in the vertical direction, and has a Fresnel lens 6a, a photoreception device 6b such as a photodiode, and so on. The Fresnel lens 6a gathers the laser light which entered through the light reception aperture 1e onto the photoreception device 6b. The photoreception device 6b generates an output current or an output voltage according to an intensity of the laser light gathered by the Fresnel lens 6a. The output current or the output voltage is inputted into the control portion.

For instance, during a cruise control system is operating, the distance detection portion in the control portion located on the circuit board 5 operates to detect the distance between the vehicle and the forward vehicle.

First, the light emitter 2 emit the laser light in front of the vehicle, via the reflector 3, the polygon mirror 4 and the light emission aperture 1d. When any object such as a forward vehicle reflects the laser light, the reflected laser light enters through the light reception aperture 1e into the photoreceptor 6b.

Thus, the photoreceptor 6b generates an output current or an output voltage according to an intensity of the laser light thereinto. The control circuit detects the output current or the output voltage, and calculates a distance D between the vehicle and the forward vehicle based on a time lag T between the emission and reception of the laser light and a velocity C of the laser light, as an equation below.
D=C×T/2

Thus, the distance between the vehicle and the forward vehicle is detected. The distance is transmitted via the connector to the devices located outside the casing 1, such as an engine ECU and a braking ECU. Thus, the engine ECU and/or the braking ECU controls the engine power and the braking force to keep the distance between the vehicle and the forward vehicle substantially unchanged.

As described above, the reflector 3 and the polygon mirror 4 makes the laser light emerging out of the light emission aperture 1d diffuse and the laser light entering the light reception aperture 1e converge at an angle of 4 degrees in the vertical direction. Thus, even if the laser light emitted out of the light emission aperture 1d reflects at the grille cover 10, the reflected light does not enter the photoreception region of the photoreceptor 6.

The grille cover 10 generally has an inclination to the vertical line so that the upper portion thereof retracts in the rearward direction. Thus, even if the laser light reflects at the rear face of the grille cover 10, the regularly reflected light is directed downward as shown with a solid line, that is, opposite to the light reception aperture 1e.

The rear face of the grille cover 10 may reflect some portion of the laser light emitted from the light emission aperture 1d and the diffusive light shown with a dotted line may enter the light reception aperture 1e. This diffusive light is quite small relative to the laser light reflected by the object, so that the diffusive light does not cause the misdetection of the distance between the vehicle and the forward vehicle.

As describe above, the object detecting apparatus has an advantage of preventing the diffusively reflected light reflected on the rear face of the grille cover 10 from entering the light receiving aperture 1e.

Especially, the inclined grille cover 10 reflects the emitted laser light toward an opposite direction from the light reception aperture 1e. Accordingly, the object detecting apparatus securely prevents the diffusively reflected light reflected on the rear face of the grille cover 10 from entering the light receiving aperture 1e.

Further, the emission and the reception angles of the laser light is set generally to 4 degrees in the vertical direction and ±18 degrees in the horizontal direction. That is, the emission and the reception ranges in the vertical direction are smaller than those in the horizontal direction. In this embodiment, the light emission aperture 1d and the light reception aperture 1e are arranged generally in the vertical direction, so that the distance between the light emission aperture 1d and the light reception aperture 1e can be close to each other to make the housing 1 compact. This serves also to make the object detecting sensor light and small in manufacturing cost.

### Second Embodiment

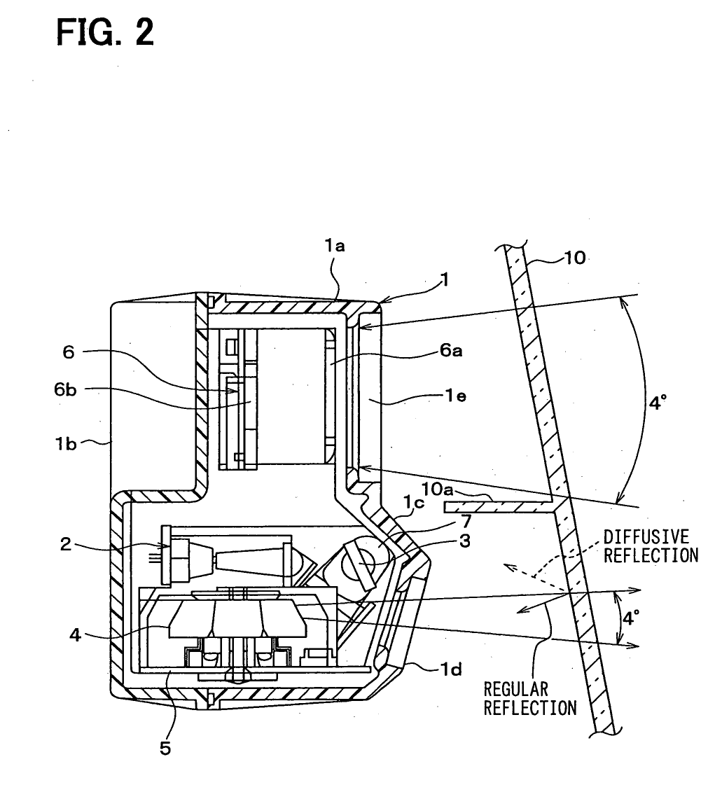

In the second embodiment shown in FIG. 2, the sectional shape of the grille cover 10 differs from that in the first embodiment. A light shield (not shown) is located between the light emission portion and the light detection portion as same as the light shield 10a of the first embodiment and projecting backward on the rear face of the grill cover 10. The light shield reflects the laser light out of the light emission aperture 1a not to enter inter into the light reception aperture 6 even if reflected on the rear face of the grille cover 10 as the diffusive reflected light toward the light reception aperture 1e.

### Third Embodiment

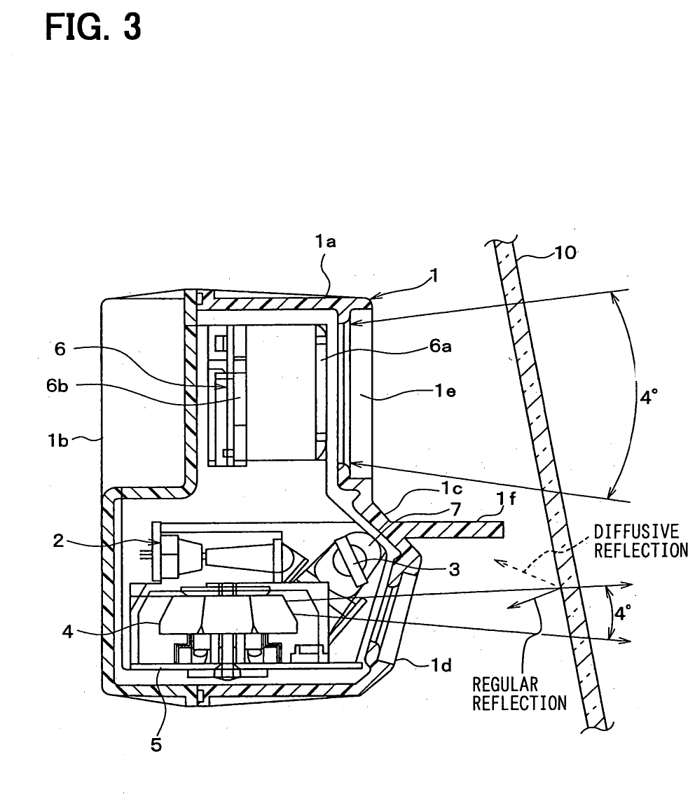

In the third embodiment shown in FIG. 3, the configuration of the casing 1 differs from that in the first embodiment. A plastic portion 1c of the casing 1 has a light shield 1f projecting forward thereon between the light emission aperture 1d and the light reception aperture 1e. This light shield 1f reflects the laser light out of the light emission aperture 1a not to enter inter into the light reception aperture 6 even if reflected on the rear face of the grille cover 10 toward the light reception aperture 1e.

### Fourth Embodiment

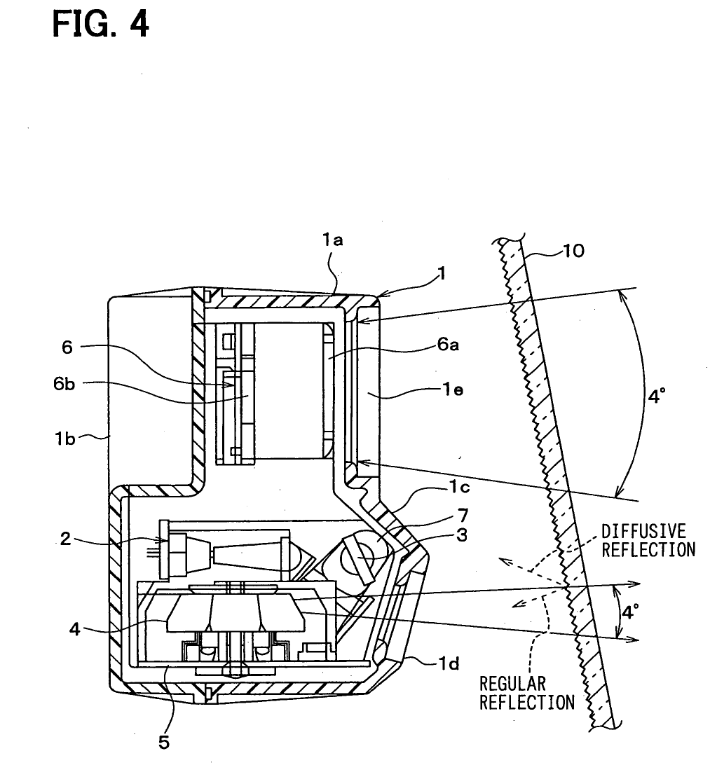

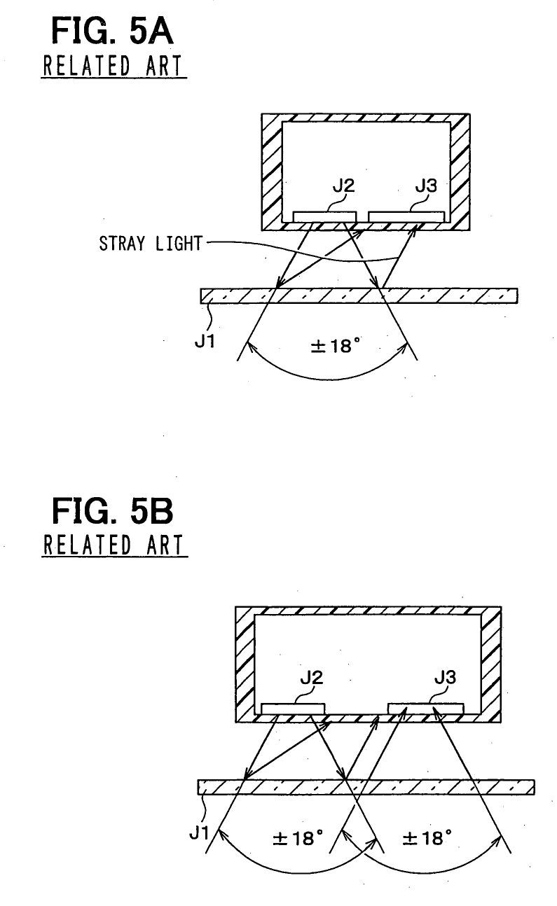

In the fourth embodiment shown in FIG. 4, the rear surface of the grille cover 10 differs from that in the first embodiment. The rear surface of the grille cover 10 has a low or non-reflection coating which decreases a light reflection coefficient thereon. Thus, the emission light is restricted from being reflected on the rear surface of the grille cover 10 to enter the reception aperture 6.

### Other Embodiments

The grille cover 10 may be a front grille having parallel bars arranged horizontally or vertically or arranged in a mesh.

The rear surface of the grille cover 10 in the first to the third embodiments also may have a low or no light reflection coefficient as that in the fourth embodiment.

The object detecting apparatus may comprise both the light shield 10a in the second embodiment and the light shield 1f in the third embodiment.

The object detecting apparatus may be located on a rear face or on a side face of the vehicle.

1. An object detecting apparatus for a vehicle having a covering portion passing light therethrough and tilted relative to a vertical direction comprising:
a light emission portion for emitting a light toward outside of the vehicle;
a light detection portion for detecting the light reflected by an object; and
a housing configured to be installed behind the covering portion and locating therein the light emission portion and the light detection portion generally in a vertical direction so that the light emission portion faces more outward portion of the covering portion than a portion which the light reception portion faces.

2. The object detecting apparatus according to claim 1,
wherein the covering portion is a grille cover.

3. The object detecting apparatus according to claim 1,
wherein a front face of the light emission portion protrudes forward of a front face of the light detection portion.

4. The object detecting apparatus according to claim 1, further comprising:
a light shield located between the light emission portion and the light detection portion and projecting forward on a front face of the housing.

5. The object detecting apparatus according to claim 1,
wherein a rear surface of the covering portion has a low reflection treatment which decreases a light reflection coefficient thereon.

6. The object detecting apparatus according to claim 1, further comprising:
a light shield located between the light emission portion and the light detection portion and projecting backward on a rear face of the covering portion.
